(19) United States
(12) Patent Application Publication
(10) Pub. No.: US 2007/0074054 A1
(43) Pub. Date: Mar. 29, 2007

(54) Clock gated pipeline stages

(76) Inventor: Lim Soon Chieh, Penang (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/237,192

(22) Filed: Sep. 27, 2005

(51) Int. Cl. G06F 1/00

(52) U.S. Cl. 713/300

(57) ABSTRACT

Methods and apparatus are described that gate a clock signal from pipeline stages of a processor. In one embodiment, gated clock logic determines which pipeline stages are active and which pipeline stages are idle. The gated clock logic permits a clock signal to drive active stages and gates the clock signal from driving idle stages.

### BACKGROUND

Computing devices may include one or more processors to execute instructions of software and/or firmware. Such processors commonly include a pipeline to execute a single instruction in a series of pipeline stages Each stage may perform a separate sub-operation during the execution of a given instruction. Due to the division of labor across the series of stages, the processor may execute several instructions simultaneously with each instruction being processed by a different stage. The stages may be driven by a clock signal in order to control the flow of an instruction from one stage to the next stage of the pipeline. Further, each stage of the pipeline consumes substantial power due to synchronous logic of the stages being clocked by the clock signal.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computing device having a processor with a pipeline.

FIG. 2 illustrates a pseudo code and a bubble that may be introduced into a pipeline of a computing device as a result of executing the pseudo code.

FIG. 3 illustrates an embodiment of gated clock logic to gate a clock signal from stages of a pipeline.

FIG. 4 illustrates example signal output of the gated clock logic of FIG. 3.

FIG. 5 illustrates a pseudo code and an idle pipeline that may result from execution of the pseudo code.

FIG. 6 illustrates another embodiment of gated clock logic to gate a clock signal from stages of a pipeline.

FIG. 7 illustrates example signal output of the gated clock logic of FIG. 6.

FIG. 8 illustrates a method of gating a clock signal from pipeline stages of a processor.

### DETAILED DESCRIPTION

The following description describes operating pipeline stages of a processor in a manner that attempts to reduce power consumption. In the following description, numerous specific details such as logic implementations, resource partitioning/sharing/duplication implementations, types and interrelationships of system components, and logic partitioning/integration choices are set forth in order to provide a more thorough understanding of the present invention. However, one skilled in the art will appreciate that the invention may be practiced without such specific details. In other instances, control structures, gate level circuits, and full software instruction sequences have not been shown in detail in order not to obscure the invention. The included descriptions are submit to be sufficient to enable those of ordinary skill in the art to implement appropriate functionality without undue experimentation.

References in the specification to “one embodiment”, “an embodiment”, “an example embodiment”, and other similar phrases indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The following description may refer to various signals as being asserted or de-asserted to indicate at least two distinct states of the respective signal. Whether a particular signal is asserted or de-asserted via a high signal, a low signal, a positive differential signal, a negative differential signal, or some other signaling technique is implementation dependent. An embodiment may use one or more of these signaling techniques to assert and de-asset various signals.

The following description may reference similar components using a reference label and subscript (e.g. REF_{SUB}). When referring to a specific component of the similar components, a reference label with a numeric subscript (e.g. REF₁) will generally be used. A group of similar components that may include a variable number of members may be identified with a list of reference labels having numeric subscripts and a last reference label having an alphabetic subscript to represent the variable number (e.g. REF₁, REF₂ . . . REF_{X}). Finally, for brevity purposes, the reference label (REF) alone associated with similar components may be used to generally refer to such similar components as a whole or may be used to generally refer to a component of the similar components where pointing out a specific component does not aid in understanding. However, such designations are merely to aid the description and are not meant to limit the scope of the appended claims. Embodiments may have multiple components of a component described in the singular, only a single component of components described in the plural, and may not include some components whether described in the singular or plural.

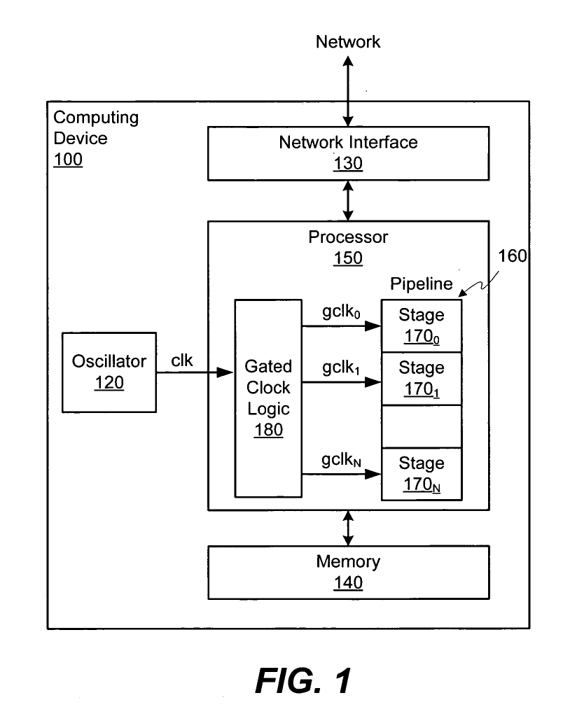

An embodiment of a computing device 100 such as for example, a network router, network switch, a laptop computer system, a desktop computer system, a server computer system, a set-top device, a hand phone, a hand-held computing device, or other similar device is illustrated in FIG. 1. The computing device 100 may comprise an oscillator 120, a network interface 130, a memory 140, and a processor 150. The oscillator 120 may generate one or more clock signals to drive synchronous components of the computing device 100 such as the network interface 130, the memory 140, and the processor 150. As will be discussed below, the oscillator 120 may generate a clock signal clk that drives the operation of the processor 150 and this clock signal may be gated in a manner that attempts to reduce power consumption of the processor 140 and/or the computing device 100 as a whole.

The network interface 130 may provide an interface between the computing device 100 and a network to facility data communication between the computing device 100 and other devices coupled to a network. In particular, the network interface 110 may comprise analog circuitry, digital circuitry, antennae, and/or other components that provide physical, electrical, and protocol interfaces to transfer packets between the computing device 100 and a wired and/or wireless network.

The memory 140 may comprise dynamic random access memory (DRAM), a static random access memory (SRAM), read only memory (ROM), flash memory, and/or other types of memory devices. The memory 140 may store instructions and data to be executed and processed by the processor 150. In particular, the memory 280 may store multi-threaded applications, operating systems, services, and/or other multi-threaded software. The memory 280 may further store single threaded applications, operating systems, services, and/or other single-threaded software.

The processor 150 may comprise one or more pipelines 160 to process instructions. For example, the processor 150 may comprises an Intel® IXP2400 network processor, an Intel® Pentium® 4 processor, an Intel® Itanium® 2 processor, an Intel® Xeon® processor, an NVIDIA® GeForce™ graphics processor, and/or some other type of pipelined processor. The pipeline 160 may execute or process a single instruction in a series of pipeline stages 170₀, 170₁ . . . 170_{N} such as 5 stages, 10 stages, 20 stages, or some other implementation dependent number of stages. Each stage 170 may perform a separate sub-operation during the execution of a given instruction. For example, an instruction may pass through a fetch instruction phase, an instruction decode phase, a fetch operands phase, an execution phase, and a write data phase where each phase may be implemented by one or more of stages 170 of the pipeline 160.

Due to the division of labor across the series of stages 170₀, 170₁ . . . 170_{N}, the processor 150 may execute several instructions simultaneously with each instruction being processed by a different stage 170. The stages 170 may be driven by a clock signal clk of the oscillator 120 or a gated clock signal gclk derived from the clock signal of the oscillator 120 in order to control the flow of an instruction from one stage 170_{X} to the next stage 170_{X+1}. Due to interdependencies between stages 170, the frequency of the clock signal may be based upon the stage 170 having the longest execution time to ensure each stage 170 completes its phase of an instruction before processing its phase of the next instruction in the pipeline 160.

Further, the stages 170 may generate signals and update values of various registers in response to processing instructions. In particular, the stages 170 may assert a kill signal k to flush partially executed instructions from the pipeline 160. For example, an execution stage 170 may assert the kill signal k in response to determining to branch to another address and/or in response to determining that the destination of a branch was mispredicted. Other components may also may assert the kill signal k. Further, the kill signal k may be asserted to flush the pipeline 160 in response to other stimuli such as execution of other instructions or receipt of various interrupt and/or control signals.

The stages 170 may also assert an idle signal id to indicate an idle condition of the pipeline 160. For example, the stages 170 in one embodiment may assert the idle signal id in response to a swap instruction that causes the processor 150 to change to another thread of instructions at a time when no other thread is ready to be executed. Other components may also assert the idle signal id. Further, the idle signal id may be asserted in response to other stimuli such as execution of other instructions or receipt of various interrupt and/or control signals.

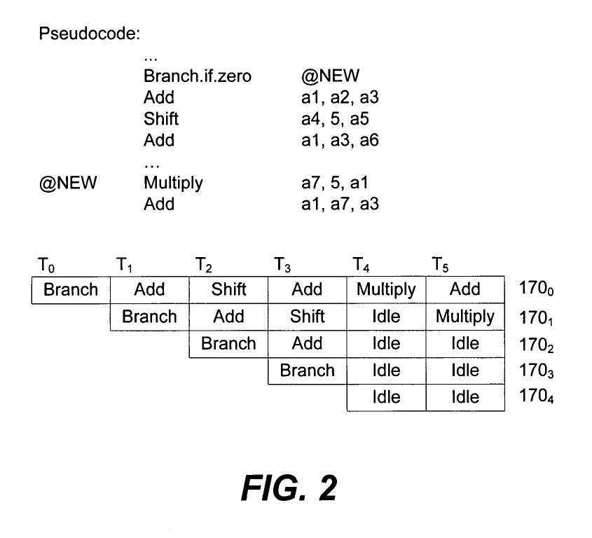

Pseudo code that introduces a “bubble” into the pipeline 160 due to a branch in a thread of instructions is depicted in FIG. 2. As depicted, the processor 150 may comprise a pipeline 160 having five stages 170₀, 170₁ . . . 170₄. A fetch instruction stage 170₀ of the pipeline 160 may fetch a branch instruction from memory 140 in clock cycle T₀, an add instruction in clock cycle T₁, a shift instruction in clock cycle T₂, an add clock cycle in clock cycle T3, and a multiply instruction in clock cycle T₄. A decode stage 170₁ may receive and decode the branch instruction in clock cycle T₁, the add instruction at clock cycle T₂, and the shift instruction in clock cycle T₃. A fetch operands stage 170₂ may fetch operands from the memory 140 and/or registers of the processor 150 for the branch instruction in clock cycle T₂ and the add instruction in clock cycle T₃.

In clock cycle T₃, an execution stage 170₃ may receive and execute the branch instruction that was loaded in clock cycle T₀. In response to processing the branch instruction, the execution stage 170₃ may determine the current thread of execution is to branch to a multiply instruction at an address identified by label @NEW. As a result of such a determination, the execution stage 170₃ may assert a kill signal and/or some other signals to inform the other stages 170 of the pipeline 160 that execution of the current thread is branching or jumping to an address identified by label @NEW. In response to assertion of the kill signal, the stages 170₀, 170₁ . . . 170₂ preceding the execution stage 170₃ flush to prevent the partially executed add, shift and add instructions of stages 170₀, 170₁, 170₂ from completing. Since the flushed partially executed instructions occur after the branch instruction, proper execution of the thread dictates that such instructions only complete if the branch instruction determines not to branch to address @NEW.

As a result of branching to address @NEW, the fetch instruction stage 170₀ loads the multiply instruction at address @NEW in clock cycle T₄. However, due to flushing of the pipeline 160 in clock cycle T₃, each of stages 170₁, 170₂, 170₃, 170₄ have no instruction to process and thus each is idle in clock cycle T₄. Further, each of stages 170₂, 170₃, and 170₄ is idle in clock cycle T₅. In particular, all stages 170 of the pipeline 160 will not fill with an instruction to process until clock cycle T₈ or possibly later. Despite being idle, conventional processors continue to drive the synchronous logic of all stages 170 with a common clock signal which causes the synchronous logic of idle and non-idle stages 170 to consume power each time the logic is triggered by the clock signal. Accordingly, power may be conserved if idle pipeline stages such as stages 170₁, 170₂, 170₃, 170₄ in clock cycle T₄ are gated from the clock signal until which time the respective stage 170 has an instruction to process.

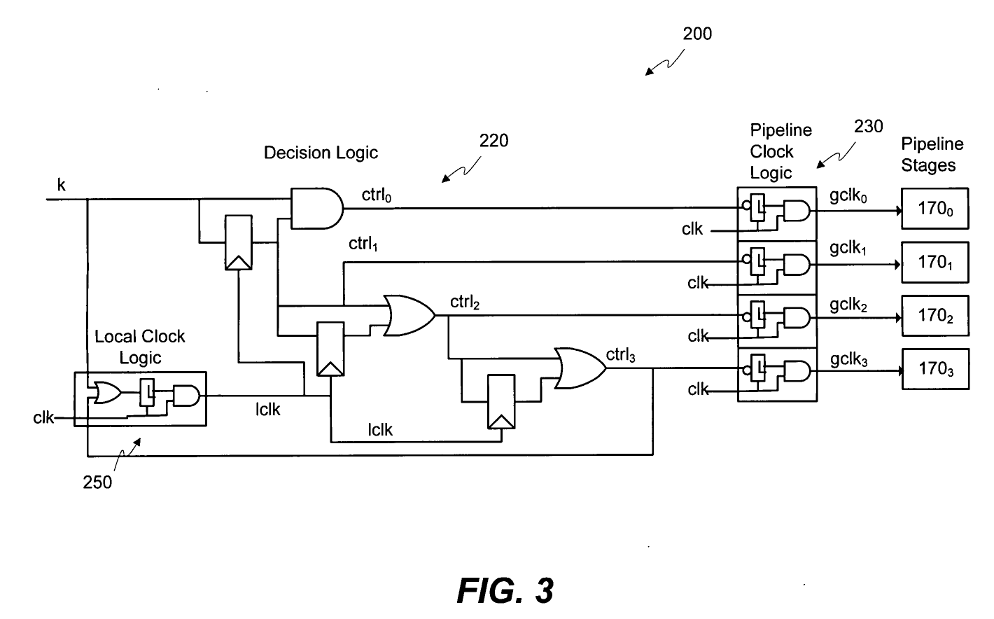

To gate pipeline stages 160 that have no instruction to execute from the clock signal of the oscillator 120, the processor 150 as depicted in FIG. 1 may further comprise gated clock logic 180. An embodiment of gated clock logic 180 is depicted in FIG. 3 as gated clock logic 200. The gated clock logic 200 may comprise decision logic 220 and pipeline clock logic 230. While the depicted gated clock logic 200 selectively gates clock signal clk from pipeline stages 170₀, 170₁, 170₂, 170₃, other embodiments of the gated clock logic 180 may support pipelines having greater or fewer pipeline stages than the four pipeline stages 170 depicted in FIG. 3.

The decision logic 220 may comprise circuitry such as, for example, the depicted AND gate, OR gates, and latches of FIG. 3 that determine based upon a kill signal k and a local clock signal lclk (i) which stages 170 have instructions and are active, and (ii) which stages 170 do not have instructions and are idle. However, other embodiments may implement the decision logic 220 using circuitry components other than the components depicted in FIG. 3. The decision logic 220 may generate control signals ctrl₀, ctrl₁, ctrl₂, and ctrl₃ that cause the pipeline clock logic 230 to gate or prevent the clock signal clk of the oscillator 120 or derived from the oscillator 120 from driving idle stages 170 and that cause the pipeline clock logic 230 to allow or permit the clock signal clk to drive active or non-idle stages 170.

The pipeline clock logic 230 comprise circuitry such as, for example, the depicted AND gates and latches that respectively generate gated clock signals gclk₀, gclk₁, gclk₂, and gclk₃ for the pipeline stages 170₀, 170₁, 170₂ and 170₃. In particular, the pipeline clock logic 230 may receive the control signals ctrl and the clock signal clk. The pipeline clock logic 230 may gate the clock signal clk from each stage 170 having a corresponding asserted control signal ctrl and may permit the clock signal clk to drive each stage 170 having a corresponding de-asserted control signal ctrl.

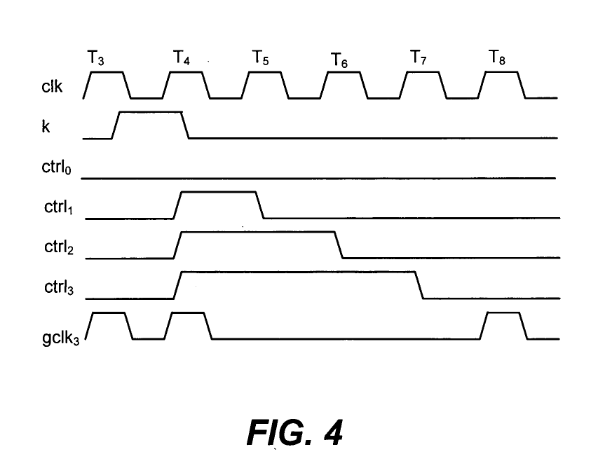

In one embodiment, the decision logic 220 may determine to assert all the control signals ctrl while the kill signal k is asserted and may determine to sequentially de-assert each control signal ctrl in response to the kill signal k being de-asserted. As depicted in FIG. 4, the kill signal k is asserted in clock cycle T₃ and de-asserted in clock cycle T₄. Accordingly, the decision logic 220 may determine to assert all control signals ctrl in clock cycle T₃ and may determine to sequentially de-assert each control signal ctrl in clock cycle T₄. As depicted, since the kill signal k was asserted for only one clock cycle, the decision logic 22 may maintain the control signal ctrl₀ associated with the beginning stage 170₀ of the pipeline 160 in an asserted state, thus resulting in the stage 170₀ loading the next instruction in clock cycle T₄. As further depicted, the decision logic 220 may sequentially de-assert one control signal ctrl₁, ctrl₂, ctrl₃ per a clock cycle in response to the de-assertion of the kill signal k to progress the instruction loaded in clock cycle T₄ through the pipeline 160. Accordingly, the decision logic 220 may generate control signals ctrl that cause the pipeline clock logic 230 to drive each active stage 170 that has an instruction with the clock signal clk while gating the clock signal from succeeding idle stages 170 that have no instruction to process.

In one embodiment, the gated clock logic 200 may further comprise a local clock logic 250 to generate the local clock signal lclk used to drive synchronous logic of the decision logic 220. The local clock logic 250 may generate the local clock signal lclk as a gated version of the clock signal clk. The local clock logic 250 may gate the clock signal clk in response to determining that the decision logic 220 may maintain the current state of control signals ctrl generated by the decision logic 220. Gating the clock signal clk from the decision logic 220 may reduce power consumption of the gated clock logic 200 by not driving synchronous circuitry of the decision logic 220 when the decision logic 220 maintains the current state of the control signals ctrl despite being driven by a clock signal.

Further, the local clock logic 250 may permit the clock signal clk to drive the decision logic 220 in response to determining that the decision logic 220 may change one or more control signals ctrl. In particular, the local clock logic 250 may determine that the decision logic 220 may change one or more control signals ctrl in response to (i) a new assertion of the kill signal k, or (ii) an indication that gating the clock signal clk in response to a previous assertion of the kill signal k has ceased.

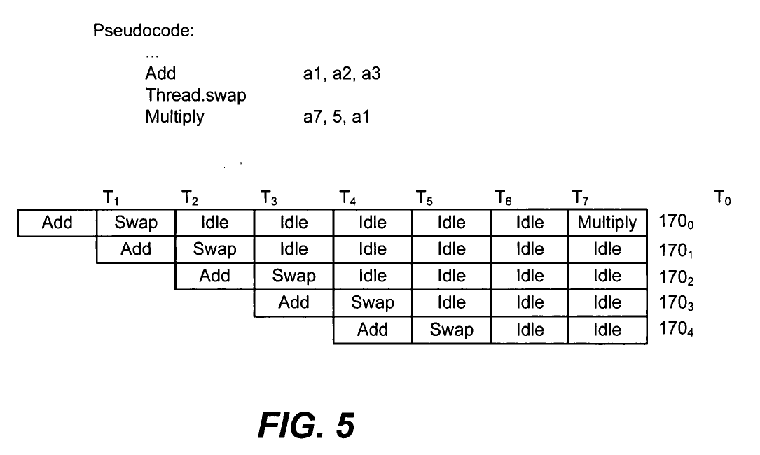

Referring now to FIG. 5, pseudo code is depicted that causes stages 170 of the pipeline 160 to idle for one or more clock cycles due to a thread or context swap at a time when no threads are ready for execution. As depicted, a fetch instruction stage 170₀ in clock cycle T₀ may fetch an add instruction from memory 140. In clock cycle T₁, the fetch instruction stage 170₀ may fetch a swap instruction and a decode stage 170₁ may receive and decode the add instruction that was fetched in clock T₀. Due to the swap instruction, stages of the pipeline 160 may idle if no thread is ready to be executed. For example, five clock cycles may pass before a thread awakens to continue execution in clock T₇. Accordingly, a five clock cycle bubble may be introduced into the pipeline 160 resulting in several idle stages 170. Despite being idle, conventional processors continue to drive the synchronous logic of all stages 170 with a common clock signal which causes the synchronous logic of idle and non-idle stages 170 to consume power each time the logic is triggered by the clock signal. Accordingly, power may be conserved if idle stages such as stages 170₀, 170₁ and 170₃ in clock cycle T₄ are gated from the clock signal while active stages such as stages 170₃ and 170₄ in clock cycle T₄ are permitted to be driven by the clock signal.

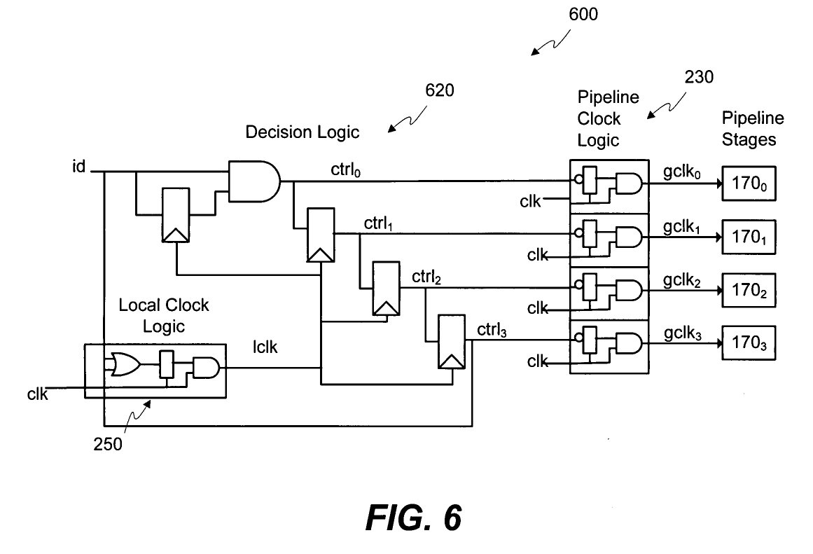

As mentioned above, the processor 150 may comprise gated clock logic 180 to gate pipeline stages 160 that have no instruction to execute from the clock signal clk of the oscillator 120. Another embodiment of gated clock logic 180 is depicted in FIG. 6 as gated clock logic 600. The gated clock logic 600 may comprise pipeline clock logic 230, local clock logic 250 and decision logic 620. The pipeline clock logic 230 and local clock logic 250 may be implemented in a manner similar to the pipeline clock logic and local clock logic of FIG. 3. While the depicted gated clock logic 600 selectively gates clock signal clk from four pipeline stages 170₀, 170₁, 170₂, 170₃, other embodiments of the gated clock logic 180 may support pipelines having greater or fewer pipeline stages than the four pipeline stages 170 depicted in FIG. 6.

The decision logic 620 may comprise circuitry such as, for example, the depicted AND gate and latches of FIG. 6 that determine based upon an idle signal id and a local clock signal lclk (i) which stages 170 have instructions and are active, and (ii) which stages 170 do not have instructions and are idle. However, other embodiments may implement the decision logic 620 using circuitry components other than the components depicted in FIG. 6. The decision logic 620 may generate control signals ctrl₀, ctrl₁, ctrl₂, and ctrl₃ that cause the pipeline clock logic 230 to gate or prevent the clock signal clk of the oscillator 120 from driving idle stages 170 and that cause the pipeline clock logic 230 to allow or permit the clock signal clk to drive active or non-idle stages 170.

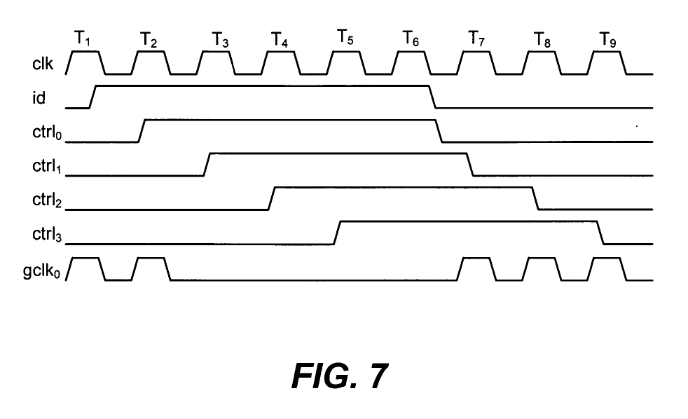

In one embodiment, the decision logic 220 may determine to sequentially assert each control signals ctrl in response to the idle signal id being asserted and may determine to sequentially de-assert each control signal ctrl in response to the idle signal id being de-asserted. As depicted in FIG. 7, the idle signal id is asserted in clock cycle T₁ and de-asserted in clock cycle T₆. Accordingly, the decision logic 620 may determine to sequentially assert each control signal ctrl in clock cycle T₁ and may determine to sequentially de-assert each control signal ctrl in clock cycle T₆. As depicted, the decision logic 620 may sequentially assert one control signal ctrl per a clock cycle in response to the assertion of the idle signal id to sequentially gate the clock signal clk from a beginning stage 170₀ to and final stage 170₃ of the pipeline 160 to permit instructions already in the pipeline 160 to proceed through the stages 170 while gating the clock signal clk from idle stages 170 that precede active stages 170 that have instructions to process. Further depicted, the decision logic 220 may sequentially de-assert one control signal ctrl per a clock cycle in response to the de-assertion of the idle signal id to progress instructions through stages 170 of the pipeline 160 while gating the clock signal clk from idle stages 170 that succeed active stages 170 that have instructions to process.

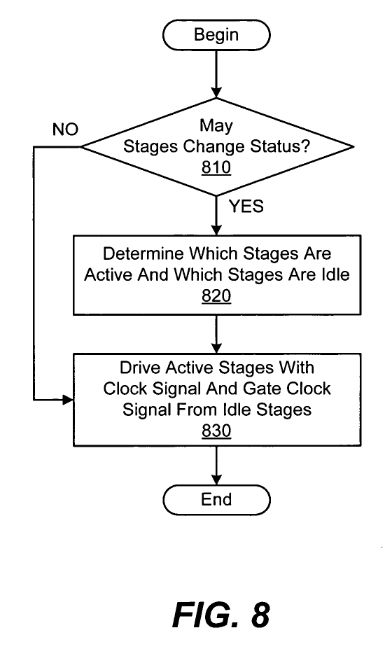

A method of gating a clock signal from stages of a pipeline is depicted in FIG. 8. In block 810, gated clock logic 180 may determine whether status of the stages 170 may change in the current clock cycle. In particular, the local clock logic 250 may determine that the status may change if the kill signal k, the idle signal id, or the control signal ctrl_{N} for the final stage 170_{N} of the pipeline 160 is asserted. In response to determining that the status of the stages 170 may change, the gated clock logic 180 in block 820 may determine which stages 170 are active and which stages 170 are idle. In one embodiment, the decision logic 220, 620 may determine based upon an a local clock signal lclk, a kill signal k, and an idle signal id which stages 170 are idle and which stages 170 are active. Further, the decision logic 220, 620 may generate control signals ctrl indicative of which stages 170 are active and which stages 170 are idle.

In block 830, the gated clock logic 180 may permit a clock signal clk to drive active stages 170 and may gate the clock signal clk from driving idle stages 170. In one embodiment, the pipeline clock logic 230 may received control signals from the decision logic 220, 620. Further, the pipeline clock logic 230 may drive stages 170 associated with asserted control signals with the clock signal clk and may gate the clock signal clk from stages associated with de-asserted control signals.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A power saving method for a processor that executes an instruction in a series of pipeline stages, comprising
preventing a clock signal from driving a first pipeline stage of the series of pipelines stages in response to determining that the pipeline stage is idle, and
allowing the clock signal to drive the first pipeline stage in response to determining that the first pipeline stage is no longer idle.

2. The power saving method of claim 1 further comprising allowing the clock signal to drive a second pipeline stage of the series of pipeline stages while preventing the clock signal from driving the first pipeline stage.

3. The power saving method of claim 1, further comprising allowing the clock signal to drive a second pipeline stage while preventing the clock signal from driving the first pipeline stage, wherein the first pipeline stage precedes the second pipeline stage in an execution path of the instruction.

4. The power saving method of claim 1, further comprising allowing the clock signal to drive a second pipeline stage while preventing the clock signal from driving the first pipeline stage, wherein the first pipeline stage succeeds the second pipeline stage in an execution path of the instruction.

5. The power saving method of claim 1, further comprising
flushing the series of pipelines stages, and
determining that the first pipeline stage is idle in response to flushing the series of pipeline stages.

6. The power saving method of claim 1, further comprising
detecting no threads to execute, and
determining that the first pipeline stage is idle in response to detecting no threads to execute.

7. A processor comprising
a pipeline to execute instructions in a series of stages, wherein each stage operates based upon a clock signal, and
gated clock logic to gate the clock signal from each stage of the pipeline determined to have no instruction to execute, and to permit the clock signal to drive each stage of the pipeline determined to have an instruction to execute.

8. The processor of claim 7 wherein the gated clock logic
prevents the clock signal from driving the plurality of stages, and
allows the clock signal to drive the plurality of stages in a sequential manner after preventing the clock signal from driving the plurality of stages.

9. The processor of claim 7 wherein the gated clock logic prevents, in a sequential manner, the clock signal from driving a plurality of stages of the pipeline from a beginning stage of the plurality of stages.

10. The processor of claim 7 wherein the gated clock logic
gates the clock signal from driving a plurality of stages of the pipeline in response to no threads to execute, and
permits the clock signal to drive the plurality of stages in a sequential manner in response to a thread becoming executable.

11. The processor of claim 7 wherein the gated clock logic comprises
clock gating logic to selectively gate the clock signal from stages of the pipeline based on one or control signals,
decision logic to generate the one or more control signals based upon a local clock signal and status of the pipeline, and
local clock logic to generate the local clock signal to drive the decision logic.

12. The processor of claim 7 wherein the gated clock logic further comprises
clock gating logic to selectively permit the clock signal to drive stages of the pipeline based on one or more control signals,
decision logic to generate the one or more control signals based upon a local clock signal and status of the pipeline, and
local clock logic to generate, based on the clock signal, a local clock signal to drive the decision logic, and to gate the local clock signal from the decision logic in response to the clock signal being permitted to drive all stages of the pipeline.

13. A system comprising
a processor comprising at least one pipeline to execute threads in a series of stages, each stage driven by a clock signal when the stage has a thread to process and gated from the clock signal when the stage has no thread to process,
a memory to store instructions of the threads executed by the at least one pipeline of the processor, and
an oscillator to generate the clock signal that drives the at least one pipeline of the processor.

14. The system of claim 13 further comprising gated clock logic to gate the clock signal from a stage of the pipeline in response to a flushing of the pipeline.

15. The system of claim 13 wherein the processor gates the clock signal from the series of stages in response to a flushing of the pipeline, and permits one stage at a time to be driven by the clock signal after flushing the pipeline.

16. The system of claim 13 wherein the processor sequentially gates the clock signal from stages of the pipeline in response to no threads to execute and sequentially permits the clock signal to drive stages of the pipeline in response to at least one active thread to execute.

17. The system of claim 13 wherein the processor comprises
clock gating logic to selectively gate the clock signal from stages of the pipeline based on one or control signals,
decision logic to generate the one or more control signals based upon a local clock signal and status of the pipeline, and
local clock logic to generate, based upon the clock signal, the local clock signal to drive the decision logic.

18. The system of claim 13 wherein the processor comprises
clock gating logic to selectively permit the clock signal to drive stages of the pipeline based on one or more control signals,
decision logic to generate the one or more control signals based upon a local clock signal and status of the pipeline, and
local clock logic to generate, based on the clock signal, a local clock signal to drive the decision logic, and to gate the local clock signal from the decision logic in response to the clock signal being permitted to drive all stages of the pipeline.

19. A machine readable medium comprising a plurality of instructions, that in response to being executed, result in a processor
gating a clock signal from pipeline stages of the processor that have no instructions to execute, and
permitting the clock signal to drive the pipeline stages of the processor that have instructions to execute.

20. The machine readable medium of claim 19 wherein the plurality of instructions further result in the processor
gating the pipeline stages in response to flushing instructions from the pipelines stages of the processor, and
sequentially permitting the clock signal to drive the pipeline stages after the gating.

21. The machine readable medium of claim 19 wherein the plurality of instruction further result in the processor
sequentially gating the pipeline stages in response to determining all threads are asleep after a thread swap, and
sequentially enabling the pipeline stages in response to an awakened thread.
